(19) United States
(12) Patent Application Publication
(10) Pub. No.: US 2017/0220136 A1
(43) Pub. Date: Aug. 3, 2017

(54) Operating Device

(71) Applicant: Siemens Aktiengesellschaft, Muenchen (DE)

(72) Inventor: Thorsten Krueger, Warngau (DE)

(73) Assignee: Siemens Aktiengesellschaft, Muenchen (DE)

(21) Appl. No.: 15/328,725

(22) PCT Filed: May 8, 2015
(86) PCT No.: PCT/EP2015/060156

§ 371 Date: Jan. 24, 2017

(30) Foreign Application Priority Data
Jul. 24, 2014 (DE) 10 2014 214 586.4

(51) Int. Cl. G06F 3/0362; G06F 3/0482; G06F 3/01; G04G 9/00; G04G 21/08

(52) U.S. Cl. CPC G06F 3/0362; G04G 9/007; G04G 21/08; G06F 3/016; G06F 3/0482; G06F 2203/014; G06F 3/0488

(57) ABSTRACT

An operating device may include an operating element that is axially moveable about an axis of rotation, and a display unit arranged radially inside the operating element with respect to the axis of rotation and stationary with respect to the operating element. The display unit may be at least partially surrounded by the operating element. A control unit may control the display unit such that at least one selection region is displayed, which can be selected based on a displacement of the operating element. When a selection region is selected using the operating element, an operating function currently associated with the selection region is triggered. The operating device supports intuitive operation based on the immediate proximity of the operating element to the display unit.

### CROSS-REFERENCE TO RELATED APPLICATIONS

This application is a U.S. National Stage Application of International Application No. PCT/EP2015/060156 filed May 8, 2015, which designates the United States of America, and claims priority to DE Application No. 10 2014 214 586.4 filed Jul. 24, 2014, the contents of which are hereby incorporated by reference in their entirety.

### TECHNICAL FIELD

The invention relates to an operating device for an electronic device.

### BACKGROUND

Generic operating devices for invoking operating functions in electronic devices are known from the prior art. To provide a menu-driven operation, operating devices are usually assigned display units which display the input menu commands for invoking the operating function. DE 102010 042527A1 discloses a portable device having a display and an operating unit. Around the edge of the display unit four actuating elements are arranged. This creates an operating control of the portable device arranged centrally around the display unit.

The constant development of portable electronic devices is accompanied by a trend towards greater miniaturization, which requires a revision of traditional operating schemes.

A currently dominant operating scheme involves the use of touch-sensitive display units. A touch-sensitive display unit displays selection fields, which when touched cause an operating function assigned to the selection field to be invoked. This operating scheme is certainly perceived to be intuitive, but with the decreasing dimensions of the touch-sensitive display unit it is now hitting its physiological limits. This is because the decreasing dimensions of touch-sensitive display units mean that the available size of the selection fields is too small for a human being to operate with a finger.

For portable electronic devices, alternative operating schemes have been introduced, which are based on analyzing swiping gestures or spoken commands. These operating schemes require the operator to learn a routine, however, and are perceived by inexperienced operators as being less intuitive.

### SUMMARY

One embodiment provides an operating device, comprising an operating element configured for axial displacement about an axis of rotation; a display unit arranged stationary with respect to the operating element and located radially inside the operating element with respect to the axis of rotation, and at least partially surrounded by the operating element; and a control unit configured to control the display unit to display at least one selection field that is selectable based on a displacement of the operating element, and trigger an operating function assigned to the selection area in response to the selection of a respective selection field.

In one embodiment, the operating element is configurable with regard to rotational resistance, rotational locking and/or rotational stepping grid size.

In one embodiment, the operating element is designed as a circle or as an equilateral polygon.

In one embodiment, the operating element comprises a selection highlighting.

In one embodiment, the operating element and the display unit are arranged concentric to each other.

In one embodiment, the selection field has the shape of a circular segment.

In one embodiment, a selection field can be highlighted.

In one embodiment, a highlighting of the selection field is visually emphasized.

In one embodiment, the selection is made by the operating element remaining on a selection field for a specifiable time period.

In one embodiment, the selection of the selection field is effected by a radial displacement of the operating element and/or by a displacement of the operating element in the direction of the rotational axis.

In one embodiment, a highlighting mode is defined for the control unit, having a representation of the at least one selection field and at least one display mode.

In one embodiment, the control unit is set up in such a way that in the display mode, a change in the highlighting mode takes place upon displacement of the operating element.

In one embodiment, the control unit is set up in such a way that the selection of a selection field takes place in the highlighting mode.

Another embodiment provides a mobile computing device configured to be worn on a wrist, and comprising an operating device as disclosed above.

Another embodiment provides a vehicle comprising an operating device as disclosed above.

Another embodiment provides an electronic device, comprising an operating device as disclosed above.

### BRIEF DESCRIPTION OF THE DRAWINGS

Example aspects and embodiments of the invention are explained in more detail below with reference to the drawings, in which:

FIG. 1 is a schematic view of a selection of selection fields on an operating device according to one embodiment of the invention; and

FIG. 2 is a schematic view of an operating device according to one embodiment of the invention on a mobile computing device designed for wearing on a wrist.

### DETAILED DESCRIPTION

Embodiments of the present invention provide an operating device which allows a straightforward and intuitive invocation of operating functions.

Some embodiments provide an operating device that comprises an operating element, which can be displaced axially about an axis of rotation and having a display unit, which is stationary with respect to the operating element and is located inside radially to the axis of rotation in relation to the operating element. The display unit is at least partially surrounded by the operating element. In addition, a control unit for controlling the display unit is provided, wherein the control takes place in such a manner that at least one selection field is displayed, which can be selected according to a displacement of the operating element. When a selection field is selected using the operating element, an operating function that is currently assigned to the selection area is triggered.

The operating device may support an intuitive operation by the fact that the operating element closely surrounds the display unit. It is possible to choose a selection field using the operating element by a displacement of the operating element while having simultaneous access to an overview of all selection fields, which in an advantageous way contain a description or presentation of the operating function to be executed. Inexperienced operators, in particular, can invoke the desired operating function without errors by actuating the operating element. By designing the contents of the display unit to be freely definable by the control unit, the available operating functions as defined by the selection fields are not subject to any technical restrictions. Therefore, in an advantageous way a status and/or state-dependent range of operating functions can be implemented by the control unit.

By providing freely definable contents of the display unit, an operating function can be triggered in an advantageous way by a multi-stage selection of hierarchical selection options, similar to a menu structure. To do this, an operator first selects a first selection field. After selecting the first selection field a set of selection options which are subordinate to or assigned to this selection are displayed in the form of appropriate selection fields, which are available for further selection.

The objective of an intuitive operation may be further supported by the inventive measure of providing an axially displaceable operating element, for example a rotary element, which in combination with the display unit, ensures a simpler overview of the selection options and a more intuitive selection compared to a linear selection method.

The operating device may allow another type of operation via the operating element in addition to operation by tapping on the integrated display unit, which according to an embodiment of the invention is designed to be touch-sensitive. Operation via the operating element may be reserved for operating functions that are intended to be invoked frequently and/or without requiring great operating effort.

In one embodiment, the operating element is designed to be configurable with regard to rotational resistance, rotational locking and/or rotational stepping grid size. These measures serve to provide an advantageous tactile feedback of a virtual engagement when selecting a desired selection field. As a means of configuring the given rotary characteristics, for example, a magnetic field strength can be adjusted while displacing an operating element relative to its counter-support, namely the operating device.

In one embodiment, the operating element has an annular design, or alternatively a design in the shape of an equilateral polygon. While the annular design advantageously allows a variable number of circular-segment shaped selection fields to be provided on the display unit, a design in the form of an equilateral polygon has the advantage of a more user-friendly handling of the operating element, which can also allow a number of selection fields corresponding to the number of edges of the polygon to be assigned to it. However, in the case of the latter design in the form of an equilateral polygon, it should be noted that the edges of the operating element partially cover the display unit during an axial displacement of the operating element, so that the image area of the display unit must be arranged below the bottom edge of the operating element. This restriction does not apply in the case of an annular design. In the case of an annular design, a radial arrangement of the operating element around a disc-shaped or cylindrical display unit is possible.

In one embodiment, the operating element comprises a selection highlighting. This optional measure facilitates a clearer assignment to a selected selection field, which in fact can be achieved simply by highlighting, for example with visual emphasis. Both measures are optional and can be selected individually or in combination. In accordance with a further development of the invention it is provided that the operating element and display unit are arranged concentric to each other. A concentric arrangement with a common center, which preferably passes through the rotational axis, relates to both the annular design of the operating element and the design as an equilateral polygon.

In one embodiment, the selection field has the shape of a circular segment. This measure allows an intuitive structuring of a circular display unit with a largely freely selectable number of circular-segment shaped selection fields.

In one embodiment, a selection field can be highlighted by a displacement of the operating element. Highlighting a selection field precedes the selection of this selection field. A selection field is first highlighted with a displacement of the operating element, and the selection is optionally visually highlighted, for example by a color change or by framing a highlighted selection field. If the operating element remains on the highlighted selection area for a specifiable length of time, a selection is invoked. Providing a highlighting advantageously allows a definition of which selection field is provided for a given selection, without this necessarily requiring a selection highlighting to be provided on the operating element.

In one embodiment, the selection is effected by a radial displacement of the operating element and/or by a displacement of the operating element along the rotational axis. This advantageous measure uses additional degrees of freedom of the operating element and allows a faster selection compared to the above design of the invention, in which the selection is invoked as soon as the operating element has been left on the highlighted selection field a for a pre-specifiable time.

In one embodiment, a highlighting mode is defined, which has a display of at least one selection field and at least one display mode. A display mode corresponds to a normal display of the display unit, in which a conventional operation of the display unit, is facilitated, for example using a touch-sensitive display unit. The control unit switches the display unit into a highlighting mode, in particular in the event of an activation, contact and/or displacement of the operating element, and displays the selection fields to be operated with the operating element to the user. The control unit is preferably set up such that a selection field can be selected in the highlighting mode only.

Another embodiment provides a mobile computing device, which is designed to be worn on a wrist, having an operating device as disclosed herein. Such mobile computer devices are also known by the term “Smart Watch”.

Another embodiment provides a vehicle having an operating device as disclosed herein. Due to the economical provision of operating elements in a vehicle, the operating device according to the invention contains particular advantages due to the freely definable facility for selecting operating functions. Specifically, depending on the status or the driving situation, alternative operating functions can be defined as selection fields in the operating device according to the invention, so that the operating device can replace a number of classical operating elements.

Another embodiment provides an electronic device having an operating device as disclosed herein. Electronic devices are understood to include all types of devices having at least partially electronic functions, for example, household appliances, production machinery, telephones, mobile telephones, remote operating units, e.g. for controlling heating or ventilation systems, heating boilers, etc.

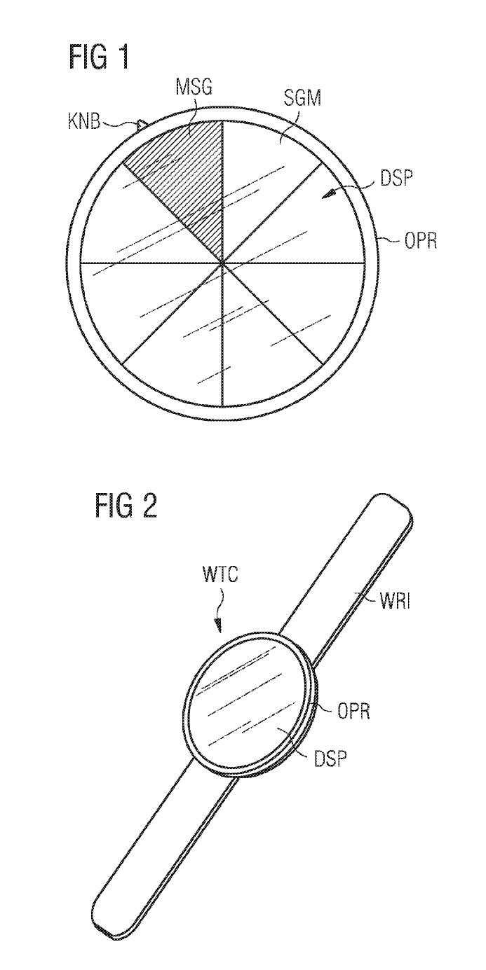

FIG. 1 shows a schematic illustration of an operating device according to an embodiment of the invention. The operating device is shown in a schematic plan view.

In this embodiment, the operating device is circular in design. In addition, this embodiment provides an annular operating element OPR, which surrounds the operating device along the circular outline thereof. A majority of the dimensions of the operating device is formed by the display unit DSP, which has a depth perpendicular to the plane of the drawing, which is to be designed according to ergonomic and/or technical specifications. The depth of the display unit DSP is selected in this embodiment so as to ensure that the device can be easily grasped using the surrounding annular operating element OPR. To further support the simple handling ability, the operating element OPR is provided, for example, with notches, grooves, edging trim or similar fittings. Alternatively or additionally, the operating element OPR has additional handling aids mounted on or in the element.

The display unit DSP may be designed to be touch-sensitive, so that in addition to the operation by means of the operating element OPR, selection items can be displayed which can be used to invoke the assigned operating functions by wiping gestures or by touching with a finger.

The operating device also comprises a control unit—not shown—for controlling the display unit DSP. This control unit is, for example, integrated in the display unit DSP. Alternatively, the control unit can be arranged outside the operating device. In this configuration, the control unit which is assigned to the operating device can be identical to a central control unit of an electronic device in which the operating device is installed.

The operating device optionally has connections—not shown—for supplying electrical power to the operating device and for data exchange with an electronic device in which the operating device is installed. A data exchange comprises, for example, an exchange of control messages with regard to an operating function to be invoked, which has been selected using the operating device. In one embodiment the operating device is designed integrally with the electronic device, so that the said connections are either omitted, or are externally not visible. Such an integral design is used in particular in a mobile computing device which is designed for wearing on a wrist. Due to the desired small size of this mobile computing device, this is, so to speak, integrated completely into the operating device according to the invention. Such mobile computer devices are also known by the term “Smart Watch”.

FIG. 2 shows such a mobile computing device WTC, which substantially consists of a design of the inventive operating device and of a bracelet WRI which is connected to the operating device, or two bracelet segments WRI which are each connected to the operating device. The operating device has a circular display unit DSP and a surrounding operating element OPR. The display unit DSP is designed such that, in addition to an actual display area on the front face of the display unit DSP, this also forms the housing of the mobile computing device WTC. In this embodiment the additional computational functions of the mobile computing device WTC, such as a controller for wireless connections, communication functions, arithmetic functions, are integrated into the appropriately extended control unit of the operating device.

The control unit of the operating device and therefore of the mobile computing device WTC also has standard design features. In particular, it runs a mobile operating system, which allows computer programs or “apps” to be executed. The unit size of the mobile computing device WTC is preferably in a range from two to five centimeters of side length. The size of the unit should be chosen in particular so that the content to be displayed on the display unit will with have a large enough image size to be compatible with anatomical constraints.

The display unit DSP as shown in FIG. 1 is displaying eight examples of selection fields MSG, SGM, including seven selection fields SGM that are not highlighted and one highlighted selection field MSG. The selection fields MSG, SGM are advantageously represented in a circular-segment shaped manner, i.e. a subdivision which allows the largest-area display of individual selection fields MSG, SGM on a circular surface.

The operating element OPR in this design has a selection highlighting KNB, which is provided on the operating element OPR. A selection highlighting KNB simplifies an assignment to a selection field MSG, SGM on the display unit DSP to be performed by the operating element OPR. The selection highlighting KNB is designed, for example, in the form of a notch, a dot, as a visual display or otherwise. Optionally or additionally, the assignment to be performed by the operating element OPR is enhanced by a visual emphasis of the highlighted selection field MSG. Both measures, i.e. the emphasis of a highlighted selection field MSG and the provision of a selection highlighting KNB, can each be optionally applied, either individually or in combination.

The control unit defines the number and type of the operating function and displays a corresponding number and selection of selection fields SGM. The items defined in particular are the number of selection areas SGM to be displayed in a particular status or condition, together with the operating function to be invoked with a given selection area SGM. Default settings taking account of operator preferences can be optionally applied.

Advantageously, one highlighting mode and one display mode are defined. A display mode corresponds to a normal display of the display unit DSP. This display mode, for example, involves a conventional operation of the touch-sensitive display unit DSP or a display of a pre-definable basic status, for example, a representation of the time of day. The control unit switches into a highlighting mode, in particular in the event of an activation, contact and/or displacement of the operating element and displays the selection fields SGM to be operated with the operating element OPR. The control unit may be configured such that a selection field SGM can be selected in the highlighting mode only.

FIG. 1 therefore shows a highlighting mode, in which a selection field MSG is highlighted. By a displacement of the operating element OPR, any desired selection field SGM can be highlighted. The highlighting is visually emphasized, for example by a color change or by framing a highlighted selection field MSG. Highlighting a selection field MSG precedes a selection of this selection field. If the operating element OPR remains on the highlighted selection area MSG for a specifiable length of time, a selection is invoked. The selection of the highlighted selection field MSG in turn triggers the operating function assigned to the highlighted selection field MSG.

A motivation underlying embodiments of the invention is to create procedures for a simple selection of different operating functions by means of an additional physical operating element OPR, for which due to their possibly frequently recurring selection, operation via a touch-sensitive display unit DSP is perceived as being cumbersome. The invocation of an operating function is to be interpreted broadly and comprises, for example, launching an app, activating a particular working mode, such as sound on/sound off, or setting a flight mode.

With appropriately chosen initial settings, frequently used operating functions can be selected simply and quickly by activating the operating element. The operator does not need to navigate through multiple menus or to activate different views on the mobile computer unit WTC by swiping gestures, in order to invoke a desired operating function. Inexperienced and occasional users, in particular, can invoke particular operating functions by activating the switch in an error-free manner.

In the following, two cases of application examples are described.

According to a first application example, a mobile computer unit WTC having a design of the operating device according to the invention is used to support a medical workflow. A ward doctor uses the mobile computer unit WTC, or Smart Watch, mainly as a normal wristwatch for displaying the time. The device was previously switched into this first working mode by selecting a first selection field. For the daily ward round, the ward doctor activates the operating element OPR and switches to a second selection field with the name “Ward round”. The selection of this second selection field invokes an assigned operating function which causes a changeover to a second working mode. In this working mode, for example, a list of patients to be attended to is displayed. If the operating unit is activated again in this second working mode, then selection fields with the names such as “Medication”, “Case History”, etc. are available. In conjunction with an identification of a currently visited patient over a wireless connection, additional patient information can therefore easily be retrieved. A mobile computer unit WTC with a design of the operating device according to the invention therefore provides intuitive support for a medical workflow, without requiring the operator to have expert knowledge in the use of the mobile computer unit WTC.

According to a second application example, a mobile computer unit WTC having a design of the operating device according to the invention supports a service technician. This person also uses the mobile computer unit WTC predominantly as a normal wristwatch for displaying the time of day. To drive to a repair site the service technician requires a computer-aided navigation system. To achieve this, the service technician actuates the operating element OPR and switches to a second selection field with the name “Navigation”. The selection of this second selection field invokes an assigned operating function which causes a changeover to a second working mode. This second working mode, for example, provides an acceptance of a navigation destination and an automatic route guidance facility with a map display on the display unit DSP. Once arrived at the repair site the service technician requires a step-by-step guide for processing a repair incident. To achieve this, the service technician actuates the operating element OPR and switches to a third selection field with the name “Repair”. The selection of this third selection field invokes an assigned operating function which causes a changeover to a third working mode. This third working mode, for example, allows receipt of a serial number and an output of step-by-step instructions for repairing the device assigned to the serial number that was entered.

In summary, the operating device according to the invention comprises an operating element, which can be displaced axially about an axis of rotation and having a display unit, which is stationary with respect to the operating element and is located inside radially to the axis of rotation in relation to the operating element. The display unit is at least partially surrounded by the operating element. In addition, a control unit for controlling the display unit is provided, wherein the control takes place in such a manner that at least one selection field is displayed, which can be selected according to a displacement of the operating element. When a selection field is selected using the operating element, an operating function which is currently assigned to the selection field is invoked. The proposed operating device supports an intuitive operation by the fact that the operating element closely surrounds the display unit.

What is claimed is:

1. An operating device, comprising:
an operating element configured for axial displacement about an axis of rotation;
a display unit arranged stationary with respect to the operating element and located radially inside the operating element with respect to the axis of rotation, and at least partially surrounded by the operating element; and
a control unit configured to:
control the display unit to display at least one selection field that is selectable based on a displacement of the operating element, and
trigger an operating function assigned to the selection area in response to the selection of a respective selection field.

2. The operating device of claim 1, wherein the operating element is configurable with regard to at least one of rotational resistance, rotational locking, or rotational stepping grid size.

3. The operating device of claim 1, wherein the operating element has a shape of a circle or an equilateral polygon.

4. The operating device of claim 1, wherein the operating element comprises a selection highlighting.

5. The operating device of claim 1, wherein the operating element and the display unit are arranged concentric to each other.

6. The operating device of claim 1, wherein the selection field has a shape of a circular segment.

7. The operating device of claim 1, wherein the control unit is configured to highlight a selection field.

8. The operating device of claim 7, wherein the control unit is configured to visually emphasis a highlighting of the selection field.

9. The operating device of claim 1, wherein the control unit is configured to effect a selection in response to the operating element remaining on a selection field for a specifiable time period.

10. The operating device of claim 1, wherein the control unit is configured to effect selection of a selection in response to at least one of a radial displacement of the operating element or a displacement of the operating element in a direction of the rotational axis.

11. The operating device of claim 1, wherein a highlighting mode is defined for the control unit, having a representation of the at least one selection field and at least one display mode.

12. The operating device of claim 11, wherein the control unit is configured to, when in a particular display mode, a change in the highlighting mode upon displacement of the operating element.

13. The operating device of claim 11, wherein the control unit is configured to effect the selection of a selection field in the highlighting mode.

14. A mobile computing device configured to be worn on a wrist, comprising:
a wrist band; and
an operating device secured to the wrist band and comprising:
an operating element configured for axial displacement about an axis of rotation;
a display unit arranged stationary with respect to the operating element and located radially inside the operating element with respect to the axis of rotation, and at least partially surrounded by the operating element; and
a control unit configured to:
control the display unit to display at least one selection field that is selectable based on a displacement of the operating element, and
trigger an operating function assigned to the selection area in response to the selection of a respective selection field.

15. A vehicle, comprising:
an operating device comprising:
an operating element configured for axial displacement about an axis of rotation;
a display unit arranged stationary with respect to the operating element and located radially inside the operating element with respect to the axis of rotation, and at least partially surrounded by the operating element; and
a control unit configured to:
control the display unit to display at least one selection field that is selectable based on a displacement of the operating element, and
trigger an operating function assigned to the selection area in response to the selection of a respective selection field.

16. (canceled)
